(19) United States
(12) Patent Application Publication
(10) Pub. No.: US 2026/0322598 A1
(43) Pub. Date: Oct. 15, 2026

(54) Data Storage Device with Secure Key Generation

(71) Applicant: Sandisk Technologies, Inc., Milpitas, CA (US)

(72) Inventors: Anish Kumar Methele Pangat Balakrishnan, Bangalore (IN); Sunil Udupi, Bangalore (IN)

(73) Assignee: Sandisk Technologies, Inc., Milpitas, CA (US)

(21) Appl. No.: 19/176,040

(22) Filed: Apr. 10, 2025

(51) Int. Cl. H04L 9/08

(52) U.S. Cl. CPC H04L 9/0861

(57) ABSTRACT

A data storage device (DSD) includes a storage medium configured to store user data, a controller, and a cryptography module (CM). The CM operates by using a cryptographic key to perform one or more cryptographic operations on received user data. The controller operates the CM to perform the one or more cryptographic operations on the user data. The controller, in response to receiving a key initialization request from a host device, generates or retrieves a device key associated with the data storage device. The controller transmits the device key to the host device. The controller receives, from the host device, a host key associated with the host device. The controller generates the cryptographic key by combining the host key and the device key.

### TECHNICAL FIELD

This disclosure relates to devices, methods, and systems for securing data stored on a data storage device (DSD), and in particular by generating encryption keys for use in one or more cryptographic operations performed on the data.

### BACKGROUND

Data storage devices (DSDs) are electronic devices with the capability to store information in the form of digital data. DSDs are typically deployed as an integrated part of, or as a removable component configured to interface with, a computing system for the purpose of improving the data transmission and storage capabilities of the system. From the perspective of the computing system, a DSD is typically implemented as a block storage device where the data stored is in the form of one or more blocks, being sequences of bytes or bits having a maximum length, referred to as block size.

DSDs are commonly used to supplement the data storage capabilities of a computer system. For example, external DSDs are often standalone physical devices which house an internal storage component, such as a hard disk drive (HDD) or a solid state drive (SSD), that provides a host computing system with an additional portion of non-volatile memory (i.e., the volume of the drive) in which to store digital data. These external drive type devices are connectable to the host computer system by way of a data path operating over a particular connectivity protocol (e.g., via Universal Serial Bus (USB) cable). In response to being connected to the host computer system, the host computer system recognizes the drive as a block data storage device such that a user of the device may access the storage of the drive by way of the data path (e.g., through operation of the host computer). Access to the drive typically enables a user to access (e.g., read, write and/or modify) user data content stored on the drive.

Some DSDs are configured for use in environments where there is a need to protect the data stored on the internal storage component. For example, if the data stored within a DSD is unprotected then it may be vulnerable to access by an unauthorized user resulting in the exposure of any associated sensitive information. An attacker may perform malicious activities on the DSD in an attempt to gain access to the stored data, including executing processes on the host computing system, often without user knowledge (termed “malware”), or on the DSD itself, such as within the internal memory of the device controller. In some cases, the attacker may attempt to read stored data from the DSD by accessing the storage component in an unauthorized manner (e.g., by physically compromising the device).

Cryptographic operations provide a means for securing digital data. For example, encryption transforms readable data (plaintext) into an unreadable format (ciphertext) using a cryptographic key, while decryption reverses this process, making the data accessible only to authorized users. Cryptographic operations such as encryption and decryption may be performed on data, such as user data, that is to be subsequently stored within a storage component of the DSD, such that the stored data remains secured even if an unauthorized user obtains physical access to the storage component.

In a conventional approach to securing user data stored on a DSD, the host computer system performs the cryptographic operations. For example, as part of a write operation the host computer system may encrypt the user data with a cryptographic key to generate encrypted user data, and then transmit the encrypted user data to the DSD for storage in the storage component. Conversely, as part of a read operation the host computer system may receive the encrypted user data from the DSD and perform a decryption operation to recover the user data.

### SUMMARY

Disclosed herein is a data storage device comprising: a non-volatile storage medium having a user accessible area configured to store user data; a data port configured to transmit at least the user data between a host device system and the data storage device by way of a data path; a cryptography module configured to receive the user data and to perform one or more cryptographic operations on the user data using a cryptographic key; and a controller configured to operate the cryptography module to perform the one or more cryptographic operations on the user data. The data storage device further is configured to, in response to receiving a key initialization request from the host device: generate or retrieve a device key associated with the data storage device; transmit the device key to the host device; receive, from the host device, a host key associated with the host device; and generate the cryptographic key by combining the host key and the device key.

In some embodiments, the host key comprises a host identifier uniquely identifying a hardware component of the host device.

In some embodiments, the host identifier is a serial number of a processing device of the host device.

In some embodiments, the device key is generated by applying a cryptographic function to a device unique identifier (DUID) of the data storage device.

In some embodiments, the controller is further configured to store the host key and the device key in a secure area of the non-volatile storage medium.

In some embodiments, the controller is further configured to generate the cryptographic key in response to a data access request from the host device, wherein performing the data access request comprises performing at least one of the one or more cryptographic operations.

In some embodiments, the controller is further configured to generate the cryptographic key by applying a cryptographic function to the host key to generate an output value and concatenating the output value with the device key.

In some embodiments, the cryptographic key is a symmetric encryption key.

In some embodiments, the controller is further configured to perform a write operation, and wherein performing the write operation comprises: receiving the user data as part of a write command issued to the data storage device by the host device; generating encrypted user data by encrypting the user data with the cryptographic key or an associated key forming a key pair with the cryptographic key; and storing the encrypted user data in the user accessible area of the non-volatile storage medium.

In some embodiments, the controller is further configured to perform a read operation, and wherein performing the read operation comprises: receiving, as part of a read command issued to the data storage device by the host device: an address of the encrypted user data; and a candidate key; validating the read command using the candidate key and the device key; and in response to a positive validation: (i) retrieving the encrypted user data from the user accessible area of the non-volatile storage medium; (ii) generating the user data by decrypting the encrypted user data with the cryptographic key or the associated key; and (iii) transmitting the user data to the host device.

Disclosed herein is a method, executed by at least one processor of a data storage device, for generating a cryptographic key used by the data storage device to perform one or more cryptographic operations on user data, wherein the method comprises: receiving a key initialization request from a host device configured to exchange data with the data storage device; in response to receiving the key initialization request, generating a device key associated with the data storage device; transmitting the device key to the host device; receiving, from the host device, a host key associated with the host device; and generating the cryptographic key by combining the host key and the device key.

In some embodiments, the host device is configured to: receive the device key in response to transmitting the key initialization request to the data storage device; store the device key in a secure area of a memory of the host device; and transmit the host key to the data storage device in response to receiving the device key.

In some embodiments, the host key comprises a host identifier uniquely identifying one or more hardware components of the host device.

In some embodiments, generating the device key comprises applying a cryptographic function to a device unique identifier (DUID) of the data storage device.

In some embodiments, the method further comprises storing the host key and the device key in a secure area of the non-volatile storage medium.

In some embodiments, the method further comprises generating the cryptographic key in response to a data access request from the host device, wherein performing the data access request comprises performing at least one of the one or more cryptographic operations.

In some embodiments, the method further comprises generating the cryptographic key by applying a cryptographic function to the host key to generate an output value and concatenating the output value with the device key.

In some embodiments, the method further comprises performing a write operation, and wherein performing the write operation comprises: receiving, by the at least one processor, a write command issued by the host device, wherein the write command comprises the user data; generating, by the at least one processor, encrypted user data by encrypting the user data with the cryptographic key or an associated key forming a key pair with the cryptographic key; and storing, by the at least one processor, the encrypted user data in a user accessible area of the non-volatile storage medium.

In some embodiments, the method further comprises performing a read operation, and wherein performing the read operation comprises: receiving, by the at least one processor, a read command issued by the host device, wherein the read command comprises: an address of the encrypted user data; and a candidate key; validating, by the at least one processor, the read command using the candidate key and the device key; and in response to a positive validation: (i) retrieving, by the at least one processor, the encrypted user data from the user accessible area of the non-volatile storage medium; (ii) generating, by the at least one processor, the user data by decrypting the encrypted user data with the cryptographic key or the associated key; and (iii) transmitting, by the at least one processor, the user data to the host device.

Disclosed herein is a data storage device comprising: means for storing user data in a non-volatile storage medium of the data storage device; means for transmitting data between a host device and the data storage device; means for performing one or more cryptographic operations on the user data using a cryptographic key; and means for generating the cryptographic key by: receiving, from the host device, a host key associated with the host device; obtaining a device key associated with the data storage device, wherein the device key is transmitted from the data storage device to the host device; and combining the host key and the device key.

### BRIEF DESCRIPTION OF DRAWINGS

Some embodiments are described herein below with reference to the accompanying drawings, wherein:

FIG. 1a is a block diagram of a conventional platform implementing server-based cryptographic key generation;

FIG. 1b is a sequence diagram of steps performed by the conventional platform of FIG. 1a for the purpose of securing user data;

FIG. 2a is a block diagram of a system for securing data stored on a data storage device (DSD) that is in communication with a host device, according to some embodiments of the proposed technology;

FIG. 2b is a block diagram of the host device of FIG. 2a, according to some embodiments of the proposed technology;

FIG. 3 is a block diagram of an example implementation of a storage medium of the DSD, according to some embodiments of the proposed technology;

FIG. 4a is a flow diagram of a method of serverless key initialization performed by the system of FIG. 2a, according to some embodiments of the proposed technology;

FIG. 4b is a sequence diagram of steps performed by the system of FIG. 2a to perform the serverless key initialization method of FIG. 4a, according to some embodiments of the proposed technology;

FIG. 5a is a flow diagram of a method performed by a controller of the DSD of the system of FIG. 2a to perform the serverless key initialization method of FIG. 4a, according to some embodiments of the proposed technology;

FIG. 5b is a flow diagram of a method performed by a host device of the system of FIG. 2a to perform the serverless key initialization method of FIG. 4a, according to some embodiments of the proposed technology;

FIG. 6 is a flow diagram of a method executed by the controller of the DSD of the system of FIG. 2a to perform generation of a device key, according to some embodiments of the proposed technology;

FIG. 7 is a sequence diagram of steps performed by the system of FIG. 2a to perform secure data access by the DSD and the connected host device, according to some embodiments of the proposed technology;

FIG. 8 is a flow diagram of a method performed by a controller of the DSD of the system of FIG. 2a to perform a write data operation, according to some embodiments of the proposed technology; and

FIG. 9 is a flow diagram of a method performed by a controller of the DSD of the system of FIG. 2a to perform a read data operation, according to some embodiments of the proposed technology.

### DESCRIPTION OF EMBODIMENTS

There are various technical challenges associated with protecting user data stored on a DSD by performing encryption and decryption operations. For example, the strength of the security provided to the user data is dependent on the ability to securely generate and protect the cryptographic key(s) (e.g., a single secret key for symmetric algorithms, or a key pair for asymmetric algorithms) against exposure. Performing cryptographic key generation on a local host device is problematic since if the local host becomes compromised then the secret key is exposed, resulting in a vulnerability of any user data that has been encrypted and stored in the DSD with the secret key. The vulnerability persists irrespective of whether a different non-compromised host device is used to access the DSD to read the data.

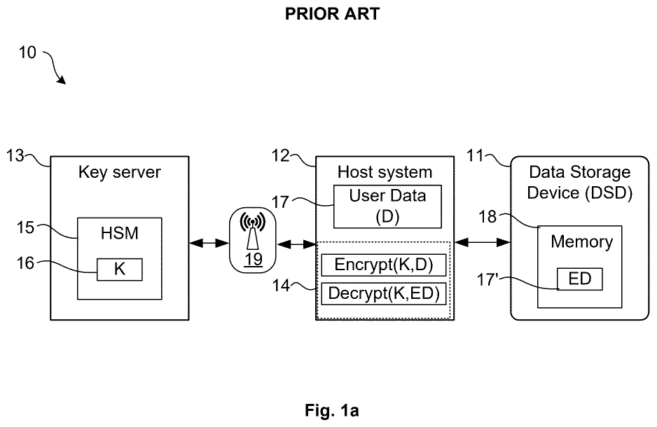

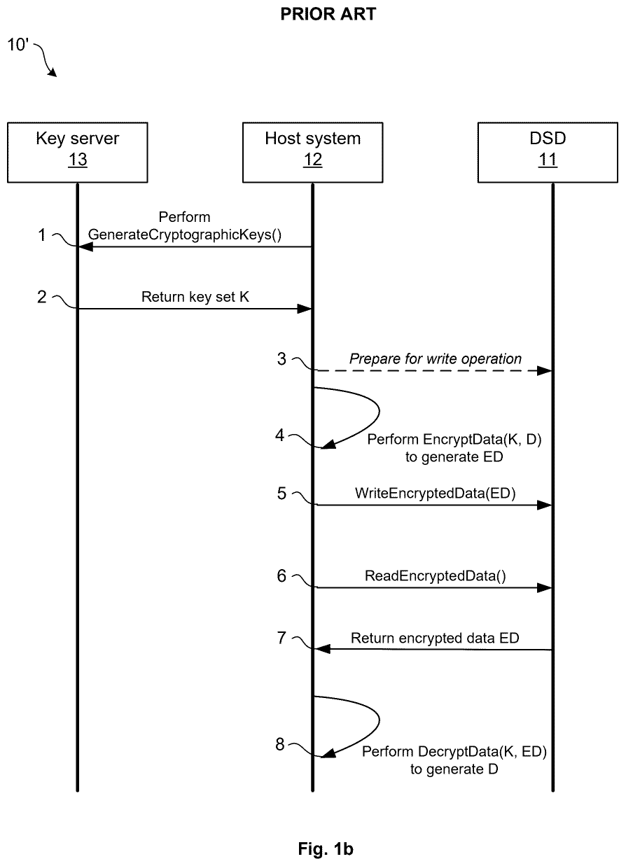

FIG. 1a illustrates a platform 10 that implements a server-based approach to cryptographic key generation for the purpose of securing user data. Key server 13 is located remotely to a local host system 12. The local host system 12 may comprise a computer system or other type of electronic device that has a processor, such as a mobile communication device. The local host system 12 is configured to communicate with both the key server 13 (e.g., via a communications network 19) and a local DSD 11. In some implementations, the key server 13 comprises a trusted physical device, such as a Hardware Security Module (HSM) 15 configured to perform cryptographic key generation, management, and exchange operations with the host system 12. For example, the HSM 15 may be configured to generate a set of cryptographic keys K 16. The host system 12 performs cryptographic operations 14, such as encryption and decryption operations with the keys K and user data (D) 17 or encrypted user data (ED) 17′ respectively. The DSD 11 is configured to store the encrypted user data (ED) 17′ in a storage component 18, such as a flash memory chip.

FIG. 1b illustrates a sequence of steps 10′ performed by the conventional platform 10 to secure user data. The host system 12 first sends a request (1) for the generation of cryptographic keys to the key server 13 (e.g., via a function call through an API). The key server 13 responds to the request by generating or retrieving the key set K which may contain, for example, a single key or a key pair, and sending (2) the key set K to the host system 12 (e.g., as a return value to the API call). The host system 12 prepares to perform a write operation (3) on user data D by executing an encrypt operation (4) on data D using the key set K, and issuing a write data command (5) to the DSD 11 with the encrypted data result ED of the encrypt operation. The host system 12 then performs a read operation on encrypted data ED by issuing a read data command (6) to the DSD 11 to receive the stored encrypted data (7), and executing a decrypt operation (8) on the received data ED using the key set K.

However, there are drawbacks with the server-based approach of platform 10, including a reliance on the availability of the remote key server 13 at the time when keys are required by the local host system 12. If network connectivity between the host system 12 and the key server 13 is disrupted, or if the key server 13 fails, then the host system 12 is unable to obtain the key set K and cannot perform the cryptographic operations 14 required to secure the user data for storage in the DSD 11.

Further, the server-based approach of platform 10 is reliant on the key server 13 being able to perform a secure key exchange with the host system 12 (i.e., to securely transfer the key set K to the host system 12). Communication between the key server 13 and the host system 12 often involves the use of a non-secure communications channel, such as for wireless transmission. This introduces a risk of the key set K being exposed during the key exchange process (e.g., if a man-in-the-middle attack is successfully executed on the communications network 19). It is therefore desired to develop devices, methods, and systems that ameliorate one or more of these difficulties, or other difficulties of the prior art, or that at least provide a useful alternative.

### Overview of the Proposed Technology

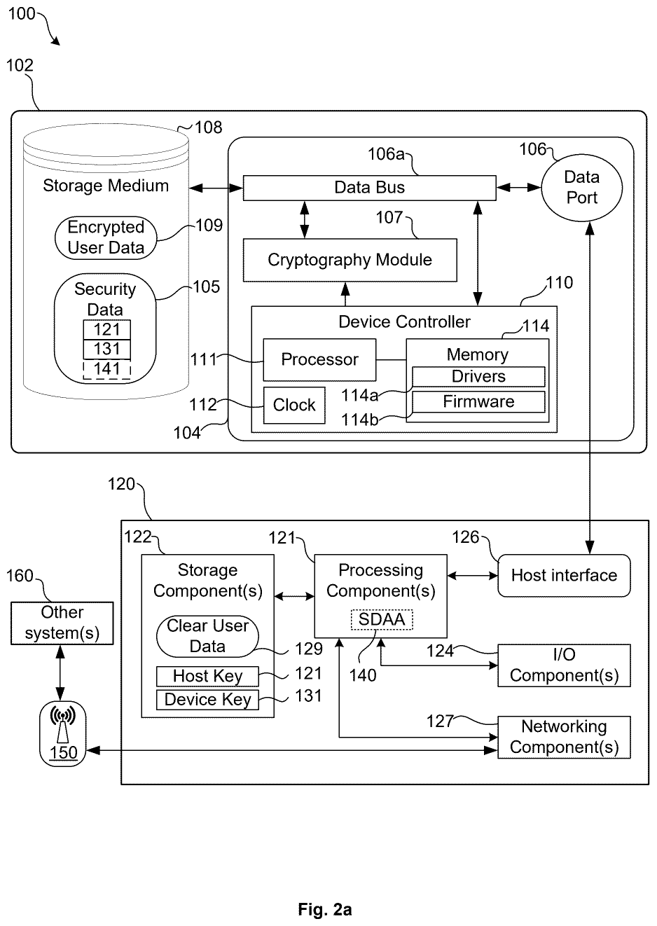

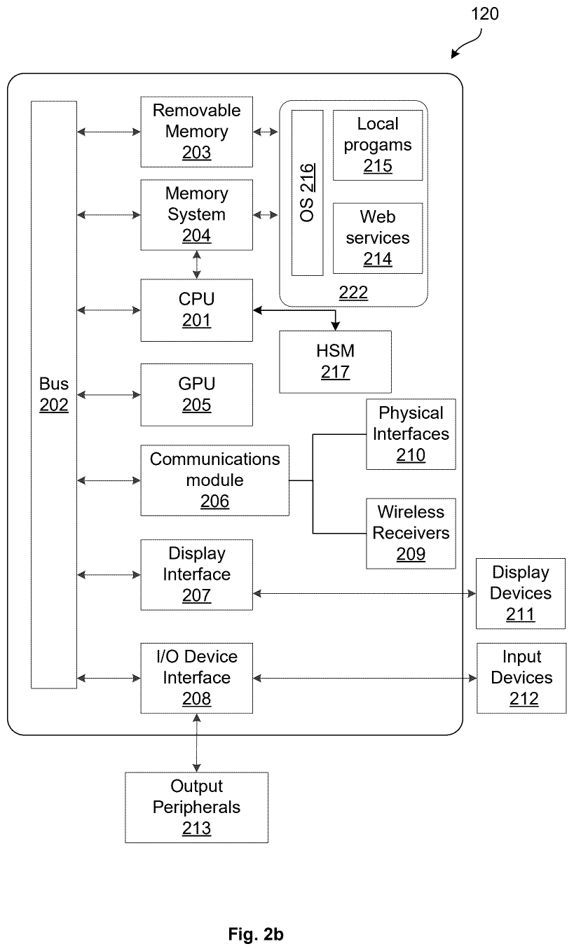

With reference to FIG. 2a, described herein are embodiments of systems, devices and methods for securing data stored on a user device (e.g., a data storage device (DSD)) 102 that is in communication with a host device 120 using serverless cryptographic key generation. One or more cryptographic keys, such as for example a single symmetric key or an asymmetric key pair, are generated for performing cryptographic operations on the data. The one or more cryptographic keys are generated locally on the DSD 102 and are specific to a pairing of the DSD 102 to the host device 120. The pairing of the DSD 102 to the host device 120 involves an exchange of keys between the respective DSD 102 and host device 120 (referred to as “key initialization” herein).

The generation of the cryptographic key(s) by the DSD 102 is referred to as “serverless” because it results from communication occurring exclusively between the DSD 102 and the host device 120. For example, key initialization may involve the DSD 102 receiving a host identifier, or key, from the host device 120, in response to providing its own key to the host system 120. In some embodiments, the key initialization binds the DSD 102 to the host device 120 such that the DSD 102 is programmed to use the corresponding host key or identifier for cryptographic key generation and subsequent cryptographic operations for the functional lifetime of the DSD 102 (e.g., until the device fails, or until a hardware reset operation is performed on the device 102).

In the described embodiments, the host device 120 commences the key initialization conducted between the DSD 102 and the host device 120. For example, key initialization may be requested by the host computing system 120 following a connection of the DSD 102 to the host device 120 (e.g. as part of pairing the DSD 102 to the host device 120). In response to receiving a request to perform key initialization from the host device 120, the DSD 102 obtains (e.g., by generating or retrieving from storage) a device key 131 associated with the DSD 102, and transmits the device key 131 to the host device 120. The DSD 102 receives, from the host device 120, a host key 121 associated with the host device 120. In response to receiving the host key 121, the DSD 102 generates the cryptographic key(s) by processing both the host key 121 and the device key 131.

The host key 121 and device key 131 respectively characterize the host device 120 and the DSD 102 uniquely among like systems and devices. In this context, the term “key” may refer to any piece of information capable of providing such a characterization once designated to the system or device. The “key” may be a cryptographic key, such as for example a 256-bit AES key used exclusively by the system or device among like systems to encrypt and decrypt data.

Alternatively, the “key” may be a general value or identifier that is associated with specific data, resources, components, or functions of the device 120 or device 102. For example, the host key 121 may be an identifier of a hardware component, or a combination of a plurality of identifiers of corresponding hardware components, of the host device 120, such as but not limited: to a Media Access Control (MAC) address assigned to a network interface for communications of the host device 120; an International Mobile Equipment Identity (IMEI) number when the host device 120 is a mobile device; and a serial number of a processing unit of the host device 120 as assigned by the manufacturer.

Following key initialization, the DSD 102 processes the device key 131 and the host key 121 and to generate a cryptographic key set 141 that permits the device 102 to secure data stored therein with respect to read and write operations requested by the host device 120. The processing of the device key 131 and the host key 121 may vary depending on, for example, the number and type of keys in the cryptographic key set 141, which in turn may depend on the cryptographic operations implemented by the DSD 102. In some embodiments, the cryptographic key set comprises a single key used for encryption and decryption according to a symmetric cryptography technique.

In other embodiments, the cryptographic key set 141 comprises a key pair, where one key of the pair is used for encryption and the other key is used for decryption according to an asymmetric cryptography technique. In some embodiments, the DSD 102 processes the device key 131 and the host key 121 by applying one or more cryptographic functions, being hashing functions such as MD5, SHA-1, SHA-256, SHA-3 and/or Blake2, and/or other functions to one or both of the keys. In some embodiments, the DSD 102 processes the device key 131 and the host key 121 by performing a combination of all or a portion of the values of the device key 131 and the host key 121, and/or of values of the output of applying one or more cryptographic functions to the same.

The proposed techniques achieve advantages over conventional approaches to securing data stored on a DSD 102 at least by avoiding the need to utilize an external system, such as a key server, to generate a cryptographic key for performing cryptographic operations. That is, in response to an initial connection or pairing between the DSD 102 and the host device 120, key generation and cryptographic operations are performed exclusively between the device 102 and system 120 (i.e., without a need for communication between the host system 120 and any other system).

Further, in the proposed techniques the cryptographic operations are performed by the DSD 102 (i.e., as “on-device” operations) using the cryptographic key that is unique to the pairing of the DSD 102 with the host device 120. The data stored in the DSD 102 is therefore cryptographically secured with a set of cryptographic keys that are specific to the host device 120 to which the DSD is paired (i.e., via a decryption operation on the user data 109). This advantageously allows the DSD 102 to control access to the user data 109 by validating any host device 120 that connects to the DSD 102 following key initialization with the host device 120 (e.g., such that decryption of the stored user data is only performed in response to a read request issued by a host device 120 in possession of the device key 131).

Further, the proposed techniques permit the dynamic generation of the cryptographic key(s) by the DSD 102 at a time following key initialization and at, or shortly before, receiving a request from the host device 120 to store user data into, or retrieve user data from, the DSD 102. This advantageously allows the DSD 102 to perform on-demand cryptographic key generation which improves the efficiency with which the DSD 102 secures data. For example, the DSD 102 may delay performing the computations required to produce a cryptographic key until such time that the key is required to encrypt or decrypt data, in accordance with a request made by the host device 120 to the DSD 102. Further, the ability to perform on-demand generation of cryptographic key(s) permits non-permanent storage of the cryptographic key(s) within the DSD 102, thereby improving the security of the device against attacks that aim to extract the cryptographic key(s) from a memory area within the device.

### Host Computing System

FIG. 2a illustrates an embodiment of a system 100 for securing user data including a user device in the form of a DSD 102 and a host computing system 120 configured for communication with the DSD 102.

In the embodiment of FIG. 2a, the host device 120 communicates with the DSD 102 by way of a host interface 126, and optionally with one or more other systems 160 by way of a communications network 150. The host interface 126 includes a device driver and a data/power interface for communicating with the DSD 102 and providing it with power. In some embodiments, the host interface 126 interface includes a data port configured for a direct physical connection with a corresponding data port 106 of the DSD 102, which may be implemented as, for example, some form of USB port (e.g., USB-A, USB-8, USB-C, mini-USB, micro-USB, etc.), a Thunderbolt port, a Power over Ethernet (PoE) port, or a similar port.

In some embodiments, the host device 120 is a mobile computing device, such as a smart phone or tablet. In other embodiments, the host device 120 is a modular computing system, such as a desktop computer. The host device 120 is configured to execute one or more software applications including, when the host is a mobile computing device, one or more mobile applications each in the form of a dedicated software program obtainable from a digital distribution platform that provides the applications for an operating system executing on the device (e.g., Google Play Store or Apple Store). Alternatively, the host device 120 may be configured to execute at least one generic software application, such as a web browser configured to render one or more webpages hosted by a dedicated web server (e.g., as provided by the manufacturer of the DSD 102).

The host device 120 includes one or more hardware devices or modules (referred as collectively as “hardware components”) according to a configuration and/or implementation of the device 120. In the described embodiments, the one or more hardware components include respective sets of processing components 123, storage components 122, networking components 127, and I/O components 124. The one or more hardware components are coupled to enable the exchange of data between sub-components by one or more internal buses.

The host device 120 is configured to execute a Secure Data Access Application (SDAA) 140, which is configured to access data stored by the storage components 122, and to generate data access requests for performing read, write, or other commands on the DSD 102 with respect to the data. The SDAA 140 has access to one or more file systems that permit the SDAA 140 to access at least parts of memory of the DSD 102 which are configured for the storage of user data in the DSD 102 by way of the connection to the host device 120. For example, the SDAA 140 may be configured to: read clear user data 129 stored in the storage components 122, where the clear user data 129 is an unsecured (e.g., plaintext) representation of user data as maintained by the host device 120; generate a request the write the clear user data 129 to a memory location of the DSD 102; and read corresponding encrypted user data 109 stored at the memory location of the DSD 102 (as described herein).

FIG. 2b illustrates a block diagram of one embodiment of the host device 120. The host device 120 comprises a central system bus 202, storage components 122 comprising a removable memory 203 and a memory system 204, processing components 123 comprising a central processing unit (CPU) 201 and optionally a graphics processing unit (GPU) 205, a set of networking components 127 comprising communications module 206, and I/O components 124 comprising a display interface 207, and an I/O device interface 208. In some embodiments the CPU 201 has an architecture consisting of a single or multiple processing cores such as, for example, a 32- or 64-bit Advanced RISC Machine (ARM) architecture (e.g., ARMvx). In other embodiments, the CPU 201 is configured according to an Intel or AMD x86 processing architecture. Generally, the CPU 201 may be implemented as any microprocessor which performs the execution of sequences of machine instructions, according to a configuration and implementation of the host device 120. The CPU 201 issues control signals to other device components by way of the system bus 202, and has direct access to at least some form of the memory system 204.

The memory system 204 provides internal media for the electrical storage of the machine instructions required to execute one or more applications. The memory system 204 may include random access memory (RAM), non-volatile memory (such as ROM or EPROM), cache memory and registers for fast access by the CPU 201, and high volume storage subsystems such as hard disk drives (HDDs), or solid state drives (SSDs). Individual memory system components, such as the high volume storage subsystems, may include separate interfaces and/or buses to the main system bus in order to increase data transfer efficiency. The removable memory system 203 may be implemented in the form of flash drives or removable high volume storage devices, connectable to the host system 120 by way of a data port implementing a particular data transfer protocol, such as for example Universal Serial Bus (USB).

In some embodiments, the host device 120GPU 205 is communicatively coupled to the CPU 201 by way of the bus 202. The GPU 205 is configured to render graphics and perform parallel processing tasks, thereby offloading these operations from the CPU 201. The GPU 205 includes multiple processing cores, each capable of executing a large number of threads simultaneously, for example to perform graphical computations and data processing tasks. In some embodiments, the host device 120 further includes additional memory modules (not shown) that are accessible by both the CPU 201 and GPU 205, allowing for efficient data transfer and shared resource utilization.

In some embodiments, the host device 120 includes a hardware security module (HSM) 217 configured to enable the host system 120 to perform one or more cryptographic operations. For example, the HSM 217 may be configured to securely generate, store, and manage cryptographic keys, and to protect data from unauthorized access. The HSM 217 interfaces with the CPU 201 and optionally with other system components by way of a secure communication channel, thereby preventing potential interception or tampering of data. In one or more embodiments, the HSM 217 is configured with features to resist tampering, such as physical shielding and/or intrusion detection mechanisms.

A portion of the non-volatile memory within the memory system 204 may contain a Basic Input/Output System (BIOS) which includes routines facilitating the communication of data and control signals between components of host device 120. The processes executed by the host device 120 are implemented as programming instructions of one or more software modules 222 stored on non-volatile storage of the memory system 204 and/or removable memory 203. In some other embodiments, the processes may be executed by one or more dedicated hardware components, such as field programmable gate arrays (FPGAs) and/or application-specific integrated circuits (ASICs).

The modules stored include an operating system 216, one or more local application programs 215, and one or more web services modules 214 providing Internet or networked data access functionality. The one or more local application programs may include the secure data access application (SDAA) 140 for performing key initialization with, and for accessing user data on, the DSD 102. Program data stored within the modules 222 may include data instructions and results produced or used by the SDAA 140. More generally application programs 215 may include methods, data structures or other software services that define data or perform functions as required by the host system 120. The data and instructions of an application program 215, and the operating system 216, may reside in multiple parts of the memory system 204, including the registers, cache, main memory, and high volume storage, or in the removable memory 203.

The system bus 202 provides functionality enabling the exchange of data between the components of the host device 120. The system bus enables the processing unit 201 to issue control signals to other components, including memory system 204, for the purpose of transferring data. The system bus 202 may be of varying structure, and may possess one or more sub-buses such as a memory bus interconnecting the memory system 204 components and/or or a peripheral bus such as AGP or PCI.

The I/O device interface 208 provides functionality enabling the user to interact with the host system 120 by way of one or more I/O devices such as a mouse and keyboard. Other external user input devices 212 which may be connected include a microphone, an IR remote control, camera, and gesture systems. The host system 120 includes one or more onboard input devices such as a touchpad or touch screen enabling a user to interact with the host system 120. The I/O device interface 208 also provides functionality for the host device 120 to instruct output peripherals 213, which may include printers, audio devices, and imaging devices.

The display device interface 207 may include one or more dedicated graphics interfaces, which transmit graphics and video signals between the host device 120 and display devices 211. In some embodiments, the dedicated graphics interfaces are provided by the GPU 205. In other embodiments, the dedicated graphics interfaces are integrated with the CPU 201. The display devices 211 may consist of inbuilt displays, including for example a display panel. In the described embodiments, display devices 211 are at least configured to display an indication of a connected device (e.g., DSD 102) visually to the user.

The host device 120 includes a communications module 206 configured to connect to wireless or wired transmission media enabling the logical connection of the host device 120 to other networked computing devices. Connections to networks or other computing devices are formed by one or more wireless transceivers 209 and/or physical interfaces 210. Communication module 206 enables the exchange of data between the host 120 and one or more other devices. Communications module 206 is configured to connect the host device 120 to the one or more other devices by a communications network which may be a local area network (LAN) or a wide area network (WAN), such as the Internet.

In the described embodiments, the communication module 206 is configured to implement one or more protocols, such as for example the IEEE 802.xx family of protocols, for wired or wireless communication with one or more other systems 160 over network 150 (i.e., including one or more LANs, WANs, and/or Internet networks).

The skilled person in the art will appreciate that many other embodiments may exist including variations in the hardware configuration of the host device 120.

With reference to FIG. 2a, the host device 120 has a host key 121 that uniquely distinguishes the host device 120 among multiple possible hosts that may be connected to the DSD 102 for the purpose of storing and accessing user data. In some embodiments, the host key 121 is a single identifier value (referred to as a “host identifier”) that uniquely identifies one or more of the hardware components of the host device 120 (referred to as one or more hardware identifiers).

For example, the host key 121 may be an identifier corresponding to one or more processing devices of the host device 120, such as a serial number of the CPU 201 of the host device 120 (i.e., a processor identifier (ID) value). Other examples of hardware identifiers of the host device 120 include: a serial number of the GPU 205; a serial number of a storage device such as a chip of RAM, a HDD, or a SSD of the memory system 204; a Media Access Control (MAC) address of the communications module 206; a serial number of a motherboard or control board on which the one or more hardware components are placed; and a unique Universal Unique Identifier (UUID) of the BIOS/UEFI firmware of the host device 120.

In some embodiments, the host key 121 a single identifier identifying a single hardware component of the host device 120. In some embodiments, the host key 121 is derived from a combination of hardware ID values of a plurality of hardware components of the host device 120. For example, the host key 121 may be derived from a concatenation of a serial number value of a RAM chip of memory system 204, a serial number of the CPU 201, and a MAC address of the communications module 206.

In some embodiments, the host key 121 is a value associated with the host device 120. For example, the host key 121 may have a value that is a pseudorandom number generated from a hardware ID value, or a combination of hardware ID values, of the one or more hardware components of the host device 120. In one or more embodiments, the host device 120 is configured to generate the host key 121 by executing a cryptographic function on the hardware ID value, or combination of hardware ID values. For example, the HSM 217 may be configured to execute a hashing function, such as SHA-1, SHA-256, SHA-384, or SHA-512, on the serial number of the CPU 201 to generate a host key 121 of a predetermined bit length.

In some embodiments, the host device 120 is configured to generate or regenerate the host key 121 dynamically in response to a change in the one or more hardware components, and therefore the corresponding hardware ID values, of the host device 120. For example, the one or more user applications executed by the processing components 123, such as the SDAA 140, may determine a change in the hardware configuration of the host device 120, and in response to the change execute an identifier generation function to regenerate the host key 121. In some embodiments, the identifier generation function is a cryptographic function executed by the HSM 217, for example to recalculate a hash value a combination of hardware IDs of a corresponding predetermined set of hardware components of the host system 120.

In some embodiments, the host key 121 is a cryptographic key associated with the host device 120. For example, the host key 121 may be a cryptographic key used by the HSM 217 or other component of the host device 120.

The host device 120 is configured to store a device key 131 associated with the DSD 102 (as described herein). In the embodiment of FIG. 2a, the device key 131 is stored in the one or more storage components 122. For example, the memory system 204 may be configured with a dedicated memory area to store the device key 131 once received by the host device 120 from the DSD 102. In some embodiments, the dedicated memory area is a secure area of the memory system 204, such as an area that is accessed as part of a Trusted Execution Environment (TEE) of the host system 120. In such embodiments, the CPU 201 processes the device key 131 securely in an isolated environment of execution (e.g., when retrieving the device key 131 to provide to the DSD 102 with a read data request).

Optionally, the host device 120 is configured to store the host key 121 in the one or more storage components 122. For example, the memory system 204 may be configured with a dedicated memory area to store the host key 121, which may be a secure area of the memory system 204 as for the storage of the device key 131. In some embodiments, the host key 121 is not stored in the one or more storage components 122, but is instead retrieved or generated dynamically when, or shortly before, the host key 121 is to be provided to the DSD 102 (e.g., as part of key initialization).

### Data Storage Device

The DSD 102 comprises a non-volatile storage medium 108, a controller 110, and a data path 104 for connecting the storage medium 108 to the host device 120. The data path 104 provides data communication between the host device 120 and the storage medium 108 by way of at least one data bus 106a. A data port 106 is configured to communicate with the host interface 126 of the host device 120, for example by way of a direct physical connection between the device 102 and host device 120.

The DSD 102 further comprises a cryptography module 107 configured to receive control signals from the controller 110 and to perform one or more cryptographic operations on user data using one or more cryptographic keys. The cryptography module 107 is configured to receive, interpret and execute commands received from the controller 110 according to a predetermined command set, such as for example the standard Advanced Technology Attachment (ATA) or serial ATA (SATA) and/or ATA Packet Interface (ATAPI) command set, which is available from Technical Committee T13. The cryptography module 107 is connected between the data port 106 and the storage medium 108 and is configured to use a cryptographic key to generate encrypted user data 109 to be stored on the storage medium 108, and to decrypt the encrypted user data 109 stored on the storage medium 108.

The DSD 102 utilizes a cryptographic key to operate the cryptography module 107 to selectively: i) decrypt encrypted user data 109 stored on the storage medium 108; and ii) encrypt one or more of: data received from the data port 106 to be stored as encrypted user data 109 on the storage medium 108; and any data stored on the storage medium 108.

In some examples, the controller 110 provides the cryptographic key to the cryptography module 107 and directs the encryption or decryption of the user data as part of its control functionality. A cryptography module 107 encrypts the user data “on the fly” as it passes through cryptography module 107 from data port 106 to storage medium 108, and decrypts the encrypted user data 109 “on the fly” as it passes through the cryptography module 107 from storage medium 108 to data port 106.

Although the embodiment depicted in FIG. 2a shows the data path 104 as wholly encompassing the controller 110, it will be appreciated that this is merely illustrative of the ability of one or more components of the controller 110 to form part of the data path 104, depending on the implementation, and that it is not necessary that all components of the controller 110 are included within the data path 104.

The controller 110 is configured to control the operation of the DSD 102. In some embodiments, the controller 110 is configured to receive, interpret and execute commands received from host device 120 according to a predetermined command set, such as for example the standard Advanced Technology Attachment (ATA) or serial ATA (SATA) and/or ATA Packet Interface (ATAPI) command set, which is available from Technical Committee T13 noting that identical functionalities can be implemented within Trusted Computing Group (TCG) Opal, Small Computer System Interface (SCSI) and other proprietary architectures.

In some embodiments, the controller 110 is implemented as an embedded device comprising a microcontroller, a memory, and one or more interfaces. The functions of the controller 110 include, but are not limited to, generating: data representing an access state of the DSD 102 (i.e., whether the DSD 102 permits access of the host computer 120 to the storage medium 108); data transmission signals to control data transmission through data path 104; data encryption signals to direct the encryption or decryption of the user data by way of cryptographic operations performed by the DSD 102, for example by invoking the cryptography module 107 of the DSD 102; and, in some embodiments, control signals to control the operation of other components of the DSD 102.

In the embodiment depicted by FIG. 2a, the controller 110 comprises: a processor 111; a clock 112 in communication with the processor 111; and a memory 114 configured to store one or more drivers 114a and a firmware 114b. The memory 114 is configured to exchange data with the processor 111 and a power source (not shown), such as an internal battery, configured to power, at least, the processor 111 and the clock 112. The firmware 114b and drivers 114a may be stored in a predetermined area of memory 114, or in one or more dedicated hardware modules, such as caches, registers, or a combination of these. The memory 114 stores data specific to the DSD 102, including at least an indication of the operational mode of the cryptography module 107. For example, the operational mode may be represented by a binary data access variable having values ‘0’ or ‘1’ representing a “secure mode” in which data received from the data path 104 is encrypted by the cryptography module 107 for storage into the storage medium 108, and a “non-secure mode” in which encrypted data retrieved from the storage medium 108 is decrypted for transmission along the data path 104.

The processor 111 receives a clocking signal from clock 112, which is used to control the timing of instructions executed by the cryptography controller 110 and/or the one or more cryptography modules 107 and sub-components (e.g., arithmetic operations conducted in the generation of random bit or byte sequences).

The processor 111 is configured to execute program code stored within the system memory 114 to issue commands for controlling the cryptographic operations performed by the DSD 102. The function of the processor 111 includes, but is not limited to: generating data representing an operational mode of the one or more cryptography modules 107; generating control instructions to control the cryptography module 107 to perform one or more cryptographic operations on data (e.g., to perform the encryption or decryption of all or a portion of user data); receiving the data, from the controller 110 or an associated interface to the data path 104, on which to perform the one or more cryptographic operations; retrieving or generating a device key associated with the DSD 102; transmitting the device key associated with the DSD 102 to the host device 120; storing data representing a host key 121 associated with the host device 120 and/or the device key 131 in the storage medium 108 and/or another region of memory of the DSD 102; and generating a cryptographic key 141 by processing the host key 121 and the device key 131; and in some embodiments, storing data representing the cryptographic key in the storage medium 108 and/or another region of memory of the DSD 102.

In some embodiments, the DSD 102 includes one or more input components (not shown) configured to accept an input from a user. For example, the input components may include a: set of buttons; and a keypad, or a similar arrangement of mechanical components that collectively enable the selection of digits or characters for entering into the device 102. The input components may also include one or more communications components configured to receive data wirelessly, such as a Near Field Communication (NFC) or Radio-frequency identification (RFID) reader.

In some implementations, the input components are configured to receive to receive authentication input from the user, such as a password, a personal identification code or number (e.g., a PIN), or a similar authentication value. The user operates the input components to provide the password, PIN, or similar authentication value as user input to the device controller 102. The controller 110 is configured to process the user input for the purpose of performing one or more cryptographic operations on the user data.

The storage medium 108 is non-transitory such as to retain the stored block data irrespective of whether the medium 108 is powered. The storage medium 108 may be a hard disk drive (HDD) with a rotating magnetic disk or a solid state drive (SSD) comprising NAND flash memory such as SLC (Single Level Cell), eMLC (Enterprise Multi Level Cell), MLC (Multi Level Cell), TLC (Triple Level Cell), and QLC (Quadruple Level Cell), and combinations of the above such as SSHD. Any other type of non-volatile storage media may also be used, including emerging non-volatile memory such as Program in Place or Storage Class Memory (SCM), such as ReRam, PCM, and MRAM. It will be appreciated that storage medium 108 can reside on a multiplicity of physical storage modules, possibly of different types. Further, the storage medium 108 may be a block data storage device, such that the user data is written in blocks to the storage medium 108 and read in blocks from the storage medium 108.

The storage medium 108 is configured to store user data. In the embodiment depicted in FIG. 2a, the user data stored in the storage medium 108 comprises encrypted user data 109 as generated, for example, by the application of an encryption algorithm executed by the cryptography module 107. That is, the cryptography module 107 is configured to generate encrypted user data 109 for storage in the storage medium 108 from the clear user data 129 received from the host device 120. The storage medium 108 may be configured to store other forms of the user data, such as the clear (i.e., unencrypted) user data 129 received from the host device 120 by way of the data bus 106a.

The storage medium 108 is further configured to store security data 105 including a device key 131 of the DSD 102 and at least one of: the host key 121; and a set of one or more cryptographic keys 141 for performing encryption and decryption of the clear user data 129 and encrypted user data 109. That is, in one implementation the DSD 102 is configured to store the device key 131 and the host key 121 received from the host device 120 during key initialization. The controller 110 may be configured to store the host key 121 as part of the security data 105 together with the set of cryptographic keys 141 and the device key 131, or to discard the host key 121 without storing it in any non-volatile storage of the DSD 102 (i.e., following the generation and storage of the set of cryptographic keys 141). In some embodiments, the controller 110 stores the host key 121 as part of the security data 105 on or shortly following receipt of the host key 121 from the host device 120.

In some embodiments, the device key 131 uniquely distinguishes the DSD 102 among a plurality of like data storage devices, such that the device key 131 permits the host device 120 to identify the DSD 102 across different systems and environments. For example, the device key 131 may be unique to the DSD 102 over a set of data storage devices with similar functions and characteristics (e.g., storage medium type, capacity, etc) to the DSD 102 and from a common manufacturer and/or vendor. In some embodiments, the device key 131 is a value of a device unique identifier (DUID) of the DSD 102. In other embodiments, the device key 131 is a value derived from the DUID such as by the application of a hashing function (e.g., SHA-256) to the DUID value (i.e., to generate a device key 131 of a predetermined bit length).

In some embodiments, the device key 131 is assigned to the DSD 102 and embedded into the device 102 at the time of manufacturing. For example, the device key 131 may be generated by a vendor or manufacturer system and stored in the storage medium 108 as part of the security data 105 prior to the connection of the DSD 102 to the host device 120. In other embodiments, the controller 110 is configured to generate the device key 131 dynamically as part of a device configuration operation, or the key initialization with the host device 120. In some embodiments, part or all of the security data 105 is not stored in the storage medium 108, but is instead stored in an area of memory local to the controller 110.

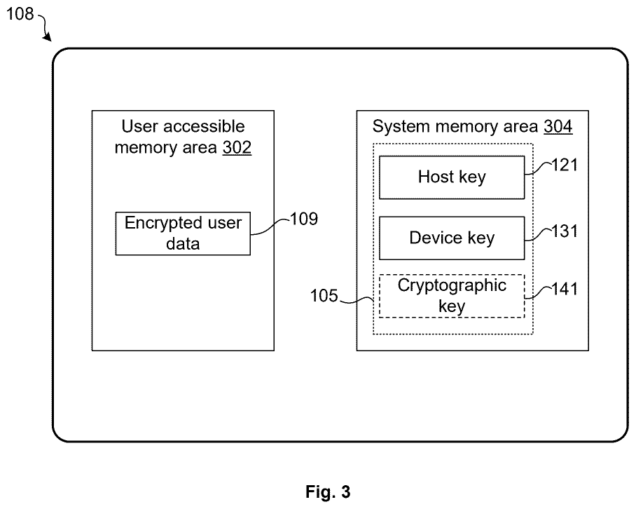

In some embodiments, the DSD 102 is configured to store one or more of the host key 121 and the device key 131 in a secure memory area of the DSD 102. FIG. 3 illustrates an example implementation of the storage medium 108 of the DSD 102 including a system memory area 304 and a user accessible memory area 302. The user accessible memory area 302 contains data that is accessible to a user by way of the host device 120, including the user data (either in encrypted or clear form).

In the embodiment depicted by FIG. 3, the security data 105 is stored within the system memory area 304 of the storage medium 108. The system memory area 304 is accessible to processor 111 of the controller 110, but is not directly accessible to the host device 120 via its file system. The contents of the system memory area 304 including the security data 105, are therefore secured against retrieval or tampering by a system external to the DSD 102 (including the host device 120).

The system memory area 304 may include secured areas or sections of the storage medium 108, such as one or more partitions or sets of memory blocks that are accessed with a protected functionality. Each secured area or section may be configured to provide read-only access to a pre-stored value of the device key 131, or write-once access to permit the storage of the host key 121, device key 131, and/or set of cryptographic keys 141, but to prevent subsequent modification of the stored value(s) (e.g., as a Programmable Read-Only Memory (PROM) area, or a Write-Once, Read-Many (WORM) area). Using secured areas of the system memory area 304 to store the host key 121, device key 131, and/or the set of cryptographic keys 141 protects the corresponding data against modification by the controller 110 after initialization in the DSD 102 (e.g., as part of the key initialization or otherwise).

### Method for Serverless Key Generation

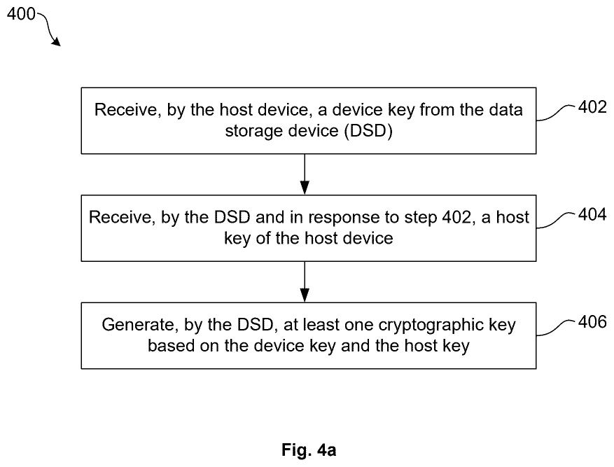

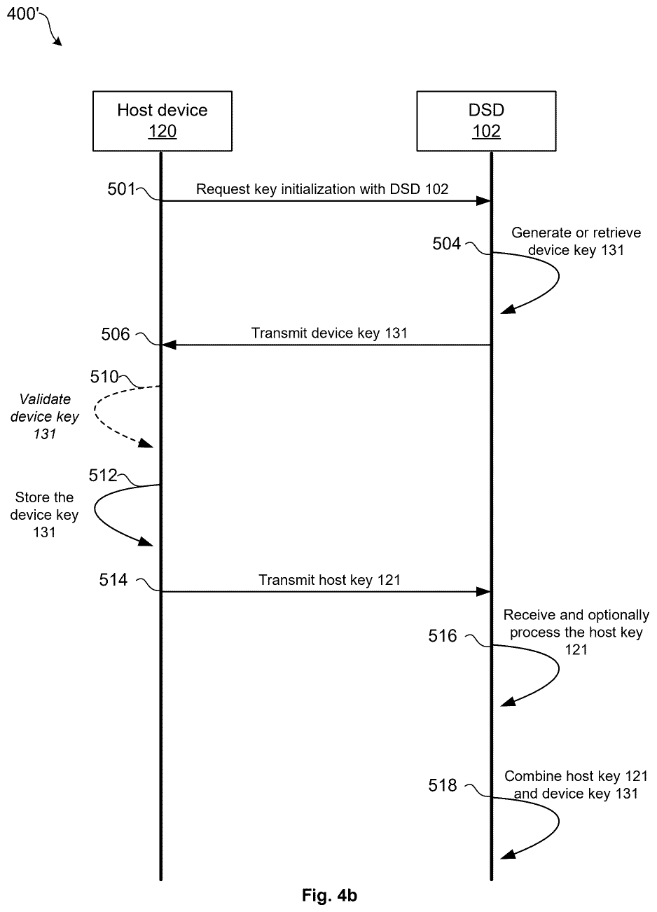

FIG. 4a illustrates a method 400 for serverless key initialization performed by the system 100, the method comprising the steps of: (Step 402) receiving, by the host device 120, a device key 131 from the DSD 102; (Step 404) receiving, by the DSD 102 and in response to step 402, a host key 121 of the host device 120; and (Step 406) generating, by the DSD 102, at least one cryptographic key (e.g., as a cryptographic key set 141) based on the device key 131 and the host key 121.

FIG. 4b illustrates a sequence of steps 400′ of the serverless key initialization method 400 as performed by system 100 to generate a cryptographic key for use by the DSD 102 to perform one or more cryptographic operations to secure user data stored within.

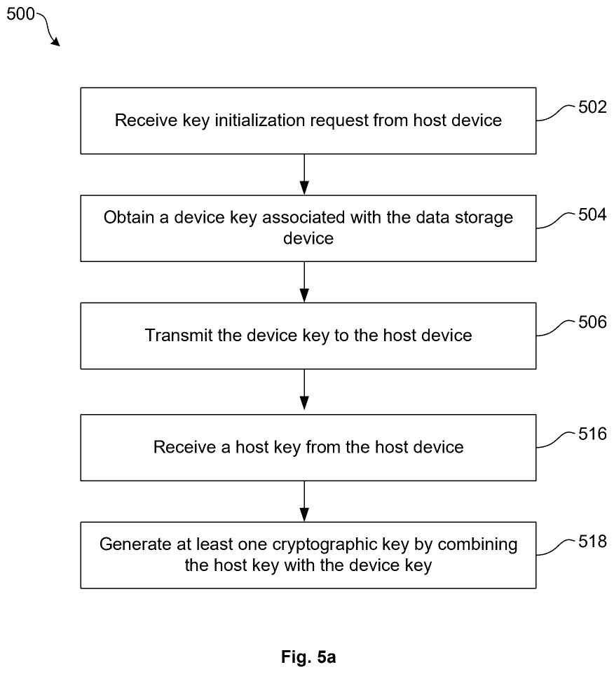

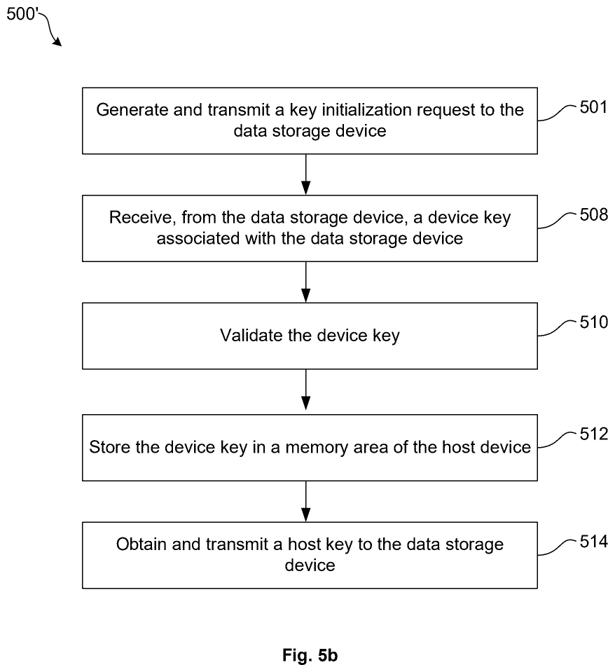

FIGS. 5a and 5b illustrate methods 500 and 500′ performed by the controller 110 of the DSD 102 and the host device 120 respectively, in accordance with the steps of method 400 of FIG. 4a.

With reference to FIG. 5b, at step 501 the host device 120 generates and transmits a request to perform key initialization (referred to as a “key initialization request” 401) to the DSD 102.

The key initialization request is a request to perform an exchange of device and host system specific keys, or corresponding identifier values, such as the host key 121 and the device key 131. In some embodiments, performing key initialization binds the DSD 102 to the specific host device 120 such that the cryptographic key set 141 generated as a result of the key initialization associates the one or more cryptographic operations performed on the user data with the unique hardware characteristics of the host system 120.

The key initialization request may be generated and transmitted to the DSD 102 by the SDAA 140 of the host system 120. In some embodiments, the SDAA 140 is configured to initiate the serverless key initialization process by generating and transmitting the key initialization request in response to one or more conditions or events, such as for example: detection of a connection between the DSD 102 and the host device 120; the existence of a secure production environment on the host device 120; and receiving, by the host device 120, authentication data representing an authorization for the binding of the DSD 102 to the host device 120.

In some embodiments, the SDAA 140 is configured to detect a first connection between the DSD 102 and the host device 120 and to automatically generate and transmit the key initialization request to the DSD 102 in response. For example, key initialization may be initiated as part of a process to register the DSD 102 with the host device 120 when the DSD 102 is first physically connected to the host device 120 (e.g., following the acquisition of the DSD 102 by a user of the host device 120).

Further, in some embodiments, the DSD 102 may be configured to perform one or more configuration operations the device 102 is first connected to the host device 120. For example, an operating system or storage management software or firmware of the DSD 102 may generate the DUID, and/or the device key 131, based on one or more device attributes, such as a serial number, layout signature, and/or other unique identifiers.

With reference to FIG. 5a, at step 502 the DSD 102 receives the key initialization request from the host device 120. In some embodiments, the DSD 102 may be bound or paired to a host device 120 by performing key initialization conditionally on the DSD 102 being in an unbound or unpaired state when the key initialization request is received. The controller 110 of the DSD 102 processes the key initialization request by searching system memory area 304 for an internal identifier indicating the status of the DSD 102 as bound or unbound. For example, the controller 110 may be configured to process the security data 105 stored in system memory area 304, or in another memory area of the DSD 102, to check for the value of any existing host key stored by the DSD 102.

In some embodiments, the controller 110 of the DSD 102 is configured to return a value in response to the key initialization request indicating whether key initialization may proceed. The returned value may be a true or false value (i.e., without indicating the host key presently stored in the security data 105). In other embodiments, the controller 110 returns the actual value of the host key stored in security data 105 in response to the key initialization request. If the DSD 102 is not bound to any host including host system 120, then no host key is stored in the system memory area 304, and a null value is returned.

At step 504, in response to determining that the key initialization request received from the host device 120 may proceed, the controller 110 obtains the device key 131 associated with the DSD 102. For example, the controller 110 may retrieve the device key 131 as a predetermined value residing in the security data 105 of the system memory area 304 (e.g., as the DUID value of the DSD 102, as calculated and stored into the DSD 102 at manufacturing). The processor 111 issues a read command to the system memory area 304 to retrieve at least the portion of the security data 105 representing the device key 131. In some embodiments, the security data 105 is stored in a secured area of system memory area 304 such as a physical and/or logical partition of memory blocks that are accessible only to the processor 111 and/or that have other access restrictions compared to the encrypted user data 109. Alternatively, the controller 110 may generate the device key 131 dynamically (e.g., in real-time or substantially real-time) in response to the key initialization request received from the host device 120.

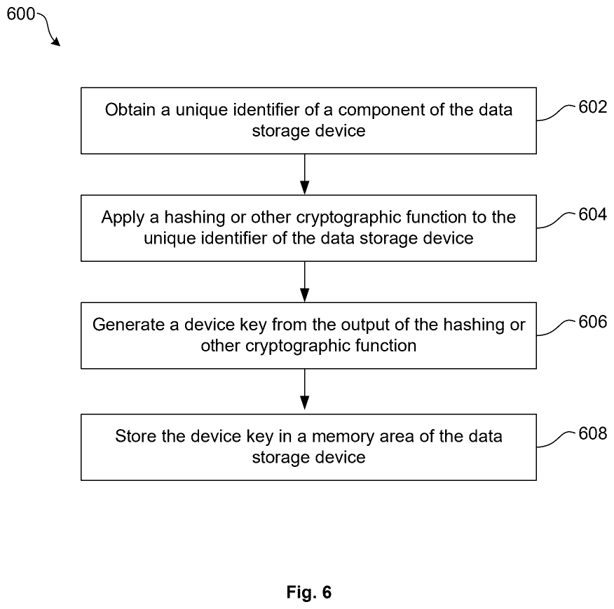

FIG. 6 illustrates a method 600 executed by the controller 110 for dynamic generation of the device key 131 from the output of performing a hashing or other cryptographic operation. At step 602, the controller 110 obtains a unique identifier of the DSD 102, which may include one or a combination of the DUID and one or more hardware identifiers of corresponding components of the DSD 102. The controller 110 then generates the unique identifier by using the one or more hardware identifiers of the corresponding components in a predetermined manner (e.g., by a concatenation of the values of a plurality of identifiers according to a predetermined order).

At step 604, the controller 110 invokes the cryptography module 107 to apply a hashing or other cryptographic function to the unique identifier of the DSD 102. For example, the cryptography module 107 may be invoked to output a 256-bit hash value of the corresponding unique identifier of the DSD 102.

At step 606, the controller 110 generates the device key 131 from the output of the hashing or other cryptographic function. For example, controller 110 may compute the device key 131 over the full set of output bits of the SHA-256 hash value, or may perform truncation to limit the value of the device key 131 to a sub-interval. In some embodiments, the controller 110 invokes the cryptography module 107 to apply a hashing or other cryptographic function to the DUID value, either alone or in combination with one or more of the hardware identifiers of the components of the DSD 102.

At step 608, the controller 110 is configured to store the device key 131 generated according to method 600 within the DSD 102 (e.g., as part of the security data 105 and/or in a dedicated memory area of the controller 110).

With reference to FIG. 5a, at step 506, the DSD 102 transmits the device key 131 to the host device 120.

With reference to FIG. 5b, at step 508, the host device 120 receives the device key 131 from the DSD 102. The SDAA 140 of the host device 120 receives the device key 131 in a predetermined form, such as for example as part of an acknowledgement or reply to the key initialization request (i.e., as transmitted to the DSD 102 at step 501).

At step 510, the host device 120 optionally validates the device key 131 received from the DSD 102. In some embodiments, the SDAA 140 is configured to perform the validation of the device key 131 based on one or more characteristics or properties of the device key 131 or the DSD 102. For example, the SDAA 140 may receive data indicating the one or more characteristics or properties of the device key 131 or the DSD 102 during an a configuration step conducted prior to commencement of the method 400.

The one or more characteristics or properties of the device key 131 or the DSD 102 may include, for example: an identifier of the DSD 102, such as a DUID value or a similar value, from which the device key 131 is derived; and/or an expected part or portion of the device key 131. The SDAA 140 uses the one or more characteristics or properties, which are known to the SDAA 140 prior to receipt of the device key 131, to validate the device key 131 by performing a comparison operation.

For example, the SDAA 140 may compare the expected part or portion of the device key 131 to the device key 131 received from the DSD 102 (e.g., by performing a bitwise comparison of the corresponding bit values). In other example, the SDAA 140 may generate a candidate device key locally on the host system 120 using the one or more characteristics or properties and compare the candidate device key to the received device key 131. The SDAA 140 provides a positive validation of the received device key 131 in response to a comparison operation indicating a match between the candidate device key and the received device key 131.

At step 512, the host device 120 stores the device key 131 in a memory area of the host device 120. For example, the SDAA 140 may issue a write data command to cause the CPU 201 to store the device key 131 in the memory system 204. In some embodiments, the host device 120 is configured to store the device key 131 in a secure area of the memory system 204 or of other memory of the host device 120. For example, the SDAA may determine a block of memory that is hardware and/or software isolated, such as an area of system 204 that is managed by the TEE of the host device 120 for storage of the device key 131.

At step 514, the host device 120 transmits the host key 121 to the DSD 102. In the embodiments depicted by FIGS. 4b and 5b, the transmission of the host key 121 to the DSD 102 is performed in response to the host device 120 receiving the device key 131 from the DSD 102. This enables the host device 120 to optionally validate the device key 131, as in step 510, and to provide its host key 121 to the DSD 102 conditionally on a positive validation result. This prevents the host device 120 from providing its host key 121 to a device that is masquerading as the DSD 102 when the step of validating the device key 131 is performed, thereby increasing the security of the serverless key initialization method 400.

With reference to FIG. 5a, at step 516 the DSD 102 receives the host key 121 from the host device 120. The controller 110 processes the host key 121 and stores the host key 121, for example in the storage medium 108. For example, processor 111 may issue a write data command to update the security data 105 stored in the system memory area 304 with the host key 121. The write data command contains reference to predetermined portion of the system memory area 304 to store the host key 121, such as a WORM area to securely store the host key 121. In some embodiments, the controller 110 is configured to store the host key 121 in a one-time programmable memory area within the DSD 102 (e.g., in an eFuse).

In some embodiments, the controller 110 stores the host key 121 in an area of local memory 114 and/or in the user accessible memory area 302 of the storage medium 108. In such embodiments, the controller 110 generates the cryptographic key set 141 (as described in step 518) without, or prior to, storing the host key 121 in the security data 105 of the system memory area 304.

Storage of the host key 121, and/or the cryptographic key set 141, into the system memory area 304 of the DSD 102 effectively binds the DSD 102 to the host device 120. That is, subsequent key initialization requests received by the DSD 102 will be rejected by the controller 110 on the basis that the device 102 is now programmed with a non-null value for the host key 121 and/or the cryptographic key set 141. In some embodiments, the controller 110 has functionality to reset the binding state of the DSD 102, such as for example by the formatting or erasing of the portion of the security data 105 corresponding to the host key 121 and/or the cryptographic key set 141.

At step 518, the controller 110 generates the cryptographic key set 141 based on the host key 121 and the device key 131. The controller 110 generates the cryptographic key set 141 by processing the host key 121 and the device key 131 according to a configuration or implementation of the cryptography module 107, such as to enable the use of the cryptographic key(s) of the key set 141 to perform one or more cryptographic operations (e.g., the encryption or decryption of blocks of user data in response to commands issued to the device 102 by the host device 120). The generation of the cryptographic key(s) of the key set 141 permits the DSD 102 to operate the cryptography module 107 to perform the one or more “on-device” cryptographic operations with the user data.

In some embodiments, the controller 110 generates the cryptographic key set 141 to consist of a single cryptographic key, such as a symmetric encryption key. The cryptography module 107 is configured to perform encryption and decryption with the encryption 141 according to one or more symmetric key-based cryptographic techniques, such as Data Encryption Standard (DES) and triple DES. In such embodiments, the encryption key 141 is stored, if at all, in a secure portion of the system memory area 304 of the DSD 102.

In some embodiments, to generate the symmetric encryption key the controller 110 combines the host key 121 with the device key 131. The combination may involve use of the value of the host key 121 and/or the device key 131, and/or the value of applying one or more functions or transformations to the host key 121 and/or the device key 131. The steps performed to achieve the combination may further depend on the form of the host key 121 and/or the device key 131. In some embodiments, the controller 110 generates the symmetric encryption key 141 by: applying a cryptographic function to the host key 121 to generate an output value; and concatenating the output value with the device key 131.

For example, the controller 110 may invoke the cryptography module 107 to apply a cryptographic hashing function H, such as SHA-256, to the host key 121 Kₕₒₛₜ to generate an output bit sequence H(Khₕₒₛₜ that uniquely corresponds to the host key 121. For a device key 131 K_{DSD} the symmetric encryption key 141 K is produced as a combination of the device key 131 and a hashed value of the host key 121:

K=H(Kₕₒₛₜ)+K_{DSD}
where the ‘+’ operator represents a concatenation. This allows the controller 110 to generate the symmetric encryption key 141 K as a value with a predetermined bit size. For example, hashing the host key 121 converts the value from an arbitrary bit size (e.g., when the host key 121 is a value of an identifier of a hardware component of the host device 120 which may have an unknown size) to a predetermined size (e.g., 256 bits) thereby providing an encryption key 141 of a fixed output size (i.e., given that the size of the device key 131 is known).

In another example, the controller 110 combines the host key 121 and the device key 131 to generate a symmetric encryption key 141 by: (i) concatenating the host key 121 Kₕₒₛₜ with the device key 131 K_{DSD} in a predetermined order; and (ii) applying a cryptographic function, such as for example the hashing function H, to the result of step (i):

K=H(Kₕₒₛₜ+K_{DSD})

In configurations where the host key 121 is a cryptographic key (e.g., as generated by HSM 217 of the host device 120) the controller 110 may be configured to perform the concatenation and hashing operation efficiently (e.g., where the bit sizes of the host key 121 and the device key 131 are matched).

In an alternative configuration, the controller 110 generates the cryptographic key set 141 as a cryptographic key pair comprising a private key and a public key. The cryptography module 107 is configured to perform encryption and decryption with the private key and the public key of the cryptographic key pair 141 according to an asymmetric cryptographic technique, such as for example RSA or Elliptic Curve Cryptography (ECC) algorithms. In one example, the controller 110 first generates one of the public key and the private key by combining the host key 121 and the device key 131 (e.g., as described above for derivation of a symmetric key), and then derives the other key according to the requirements of the cryptographic algorithm implemented by the cryptography module 107.

In some embodiments, the controller 110 generates the cryptographic key set 141 on, or shortly following, receipt of the host key 121, and stores the cryptographic key set 141 as part of the security data 105. In other embodiments, the controller 110 generates the cryptographic key set 141 only in response to receiving a data access request from the host device 120, where the data access request is associated with the DSD 102 performing at least one of the one or more cryptographic operations on user data.

For example, the data access request may comprise one or more of: a write operation involving a command to write user data to the storage medium 108; a read operation involving a command to read user data from a location in the storage medium 108; and any other operation involving a command to modify or erase user data stored at a location in the storage medium 108. In such embodiments, the controller 110 waits until there is a need to perform a cryptographic operation on the user data before generating the cryptographic key set 141. Dynamically generating the cryptographic key(s) 141 at a time shortly before the key(s) are needed to perform a cryptographic operation improves the efficiency of operation of the DSD 102, since the controller 110 does not need to determine the cryptographic key set 141 immediately on receipt of the host key 121 if the key set 141 is not required for use at that time.

### Methods for Secure Data Access

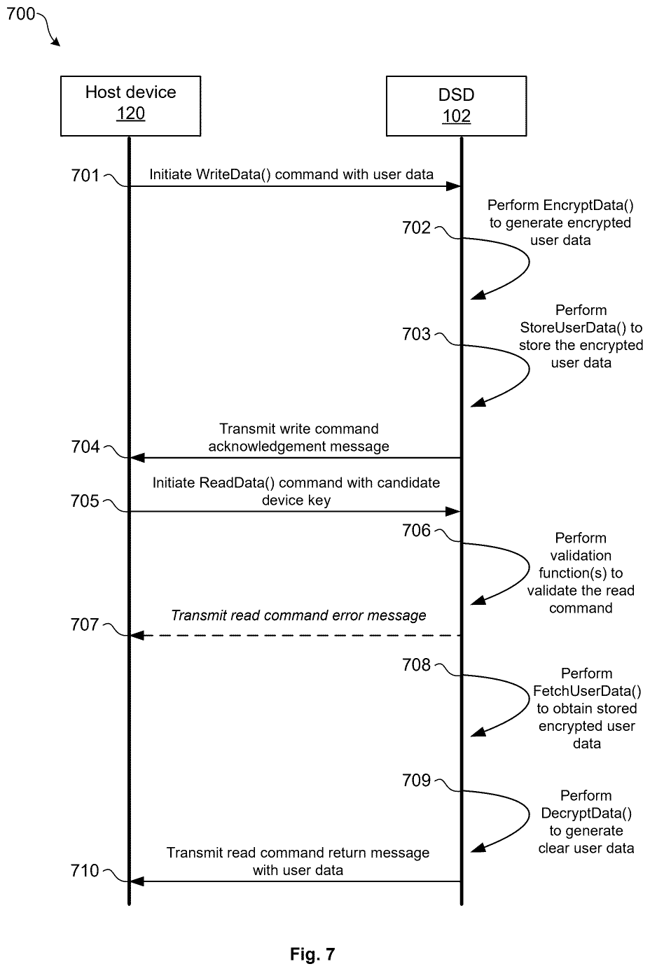

FIG. 7 illustrates a sequence of steps for 700 performing secure data access by the DSD 102 and the connected host device 120 of system 100. The secure data access steps 700 are performed following the generation of a cryptographic key by the DSD 102 according to the method 400 of FIG. 4a and the methods 500, 500′ of FIGS. 5a and 5b.

In the steps depicted by FIG. 7, the host system 120 transmits a data access request to the DSD 102, where the data access request comprises a command to perform a write operation. For example the SDAA 140 may retrieve clear user data 129 from the memory system 204 and invoke a WriteData( ) function (701) to write the clear user data 129 to the DSD 102. The host system 120 transmits the write command 701, together with the clear user data 129 to be written, to the DSD 102.

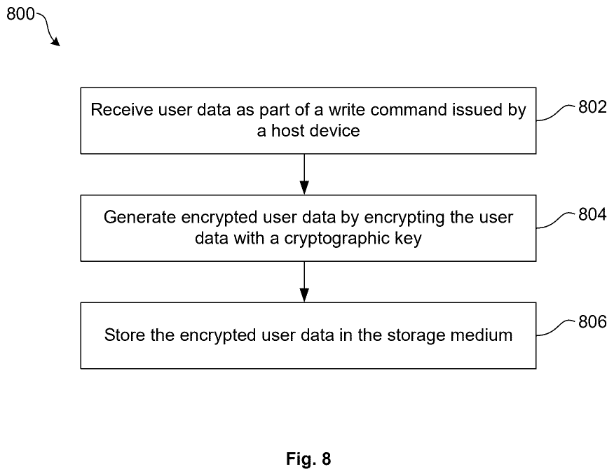

FIG. 8 illustrates a method 800 performed by the controller 110 of the DSD 102 for performing a write operation, in accordance with the steps 700 of FIG. 7. At step 802, the DSD 102 receives the user data (i.e., clear user data 129) as part of the write command 701 issued to the device 102 by the host device 120. Data representing the write command 701 and the clear user data 129 are received at the data port 106 and are transmitted to the controller 110 for processing by way of the data path 104.

At step 804, the controller 110 generates encrypted user data 109 by encrypting the clear user data 129 with a cryptographic key of the cryptographic key set 114. In some embodiments, the controller 110 invokes the cryptography module 107 to perform symmetric encryption with a single encryption key of the key set 114. The controller 110 calls an EncryptData(K, D_{clear}) function (702), where K is the symmetric encryption key of the cryptographic key set 114 and D_{clear} is the clear user data 129, to generate an output providing the encrypted user data D_{enc}.

In other embodiments, the controller 110 invokes the cryptography module 107 to perform asymmetric encryption with a key pair (K_{enc}, K_{dec}) of the key set 114. The controller 110 calls an EncryptData(K_{enc}, D_{clear}) function 702, where K_{enc} is the key of the key pair that is designated to perform encryption (e.g., the public key) which is associated with the corresponding key K_{dec} that is designated to perform encryption (e.g., the private key) and D_{clear} is the clear user data 129.

At step 806, the controller 110 stores the encrypted user data D_{enc} in the storage medium 108. The controller 110 performs a function call StoreUserData(D_{enc}) (703) to store the encrypted user data D_{enc} in the user accessible area 302 of the storage medium 108. In some embodiments, the StoreUserData( ) function determines a location in the user accessible memory area 302 for the encrypted user data (e.g., using an allocation policy such as LRU). Alternatively, the controller 110 may specify a candidate location in the user accessible memory area 302 as an input to the function (703). Optionally, the controller 110 generates and transmits a write command acknowledgement message (704) to the host system 120 on completion of the storage of the encrypted user data 109 in the storage medium 108.

With reference to FIG. 7, following the storage of encrypted user data 109 in the storage medium 108, the host device 120 transmits a data access request to the DSD 102, where the data access request comprises a command to perform a read operation (705). The host device 120 transmits the read command, together with data representing one or more read command arguments, to the DSD 102. For example, the SDAA 140 may invoke a ReadData( ) function 705 to read the encrypted user data 109 stored in the DSD 102.

The SDAA 140 provides, as an argument to the ReadData( ) function (705), data indicating a candidate device key. As the true device key 131 is stored in the memory system 204 of the host computer system 102 (i.e., as a result of successful completion of key initialization between the DSD 102 and the host system 120), the SDAA 140 retrieves the device key 131 from the memory system 204 and provides the retrieved key value as the candidate device key. An additional read command argument may comprise a location of the user accessible memory area 302 of the storage medium 108 from which data is to be read, for example corresponding to the location at which the encrypted user data D_{enc} is stored.

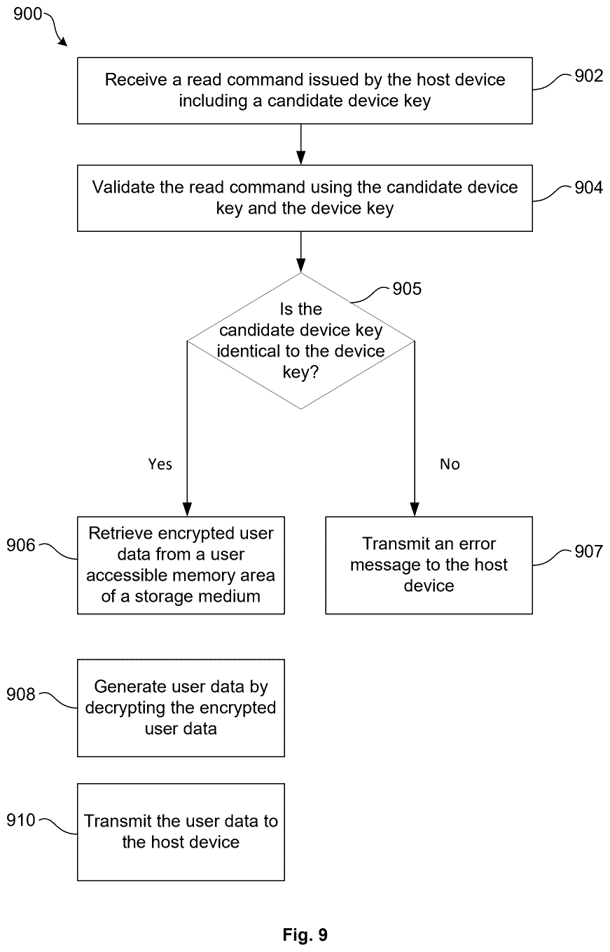

FIG. 9 illustrates a method 900 performed by the controller 110 of the DSD 102 for performing a read operation, in accordance with the steps of FIG. 7. At step 902, the controller 110 receives a read command 705 issued to the DSD 102 by the host device 120, the read command comprising: optionally, a location L of the encrypted user data 109 to be read; and a candidate device key. The location L of the encrypted user data 109 may be a memory address determined by the file system of the host device 120 configured to index the user accessible memory area 302. Alternatively, the controller 110 may determine the location of the encrypted user data 109 corresponding to the read command (e.g., by using a predetermined location associated with the host system 120).

At step 904, the controller 110 perform one or more validation functions (706) to validate the read command using the received candidate device key and the device key 131 of the DSD 102. The controller 110 retrieves the device key 131 as a portion of the security data 105 stored in the system memory area 304 of the storage medium 108.

At step 905, the controller 110 compares the candidate key value provided with the read command to the device key 131 retrieved from the system memory area 304 of the storage medium 108. For example, the controller 110 may execute a ValidateDeviceKey( ) function residing in the firmware 114a with the candidate key as an argument. The ValidateDeviceKey( ) function performs a bitwise comparison of the candidate key to the device key 131 and returns success if all bit position values of the keys are identical, and failure otherwise. That is, by executing the ValidateDeviceKey( ) function the controller 110 determines a positive validation of the read command if the candidate key is equal to the device key 131.

In response to a failure of the device key validation (e.g., based on the comparison performed at step 905), the controller 110 optionally generates and transmits an error message (707) to the host device 120 (i.e., at step 907). Otherwise, in response to a positive validation of the read command, the controller 110 performs steps 906-910 of the method 900 to execute a read operation on stored user data.

At step 906, the controller 110 retrieves the encrypted user data 109 from the user accessible memory area 302 of the storage medium 108. The controller 110 performs a function call FetchUserData(L) (708) to retrieve the encrypted user data 109 at the location L in the user accessible memory area 302. The function call returns the encrypted user data 109 which is user data previously encrypted by the cryptography module 107 using the cryptographic key set 141 specific to the pairing of the DSD 102 and the host device 120. For example, the encrypted user data 109 may be the data D_{enc} generated by the DSD 102 at step 804 as a result of a write command issued by the host device 120 with clear user data D_{clear}.

At step 908, the controller 110 generates the clear user data 129 by decrypting the encrypted user data 109 with a cryptographic key of the cryptographic key set 141. In some embodiments, the controller 110 invokes the cryptography module 107 to perform symmetric decryption with the single encryption key of the key set 114. The controller 110 calls an decryptData(K, D_{enc}) function (709), where K is the symmetric encryption key of the key set 114 and D_{enc} is the encrypted user data 109 retrieved at step 906, to generate an output providing the clear user data D_{clear}.

In other embodiments, the controller 110 invokes the cryptography module 107 to perform asymmetric decryption with a key pair (K_{enc}, K_{dec}) of the key set 114. The controller 110 calls the decryptData(K_{dec}, D_{enc}) function (709), where K_{dec} is the key of the key pair that is designated to perform decryption (e.g., the private key) which is associated with the corresponding key K_{enc} that is designated to perform encryption (e.g., the public key) and D_{enc} is the encrypted user data 109 retrieved at step 906.

At step 910, the controller 110 transmits the user data to the host device 120. For example, the controller 110 may transmit a read operation return message (710) to provide the clear user data 129, as generated from the decryption operation performed at step 908, to the host device 120 by way of the host interface 126.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A data storage device comprising:
a non-volatile storage medium having a user accessible area configured to store user data;
a data port configured to transmit at least the user data between a host device and the data storage device by way of a data path;
a cryptography module configured to receive the user data and to perform one or more cryptographic operations on the user data using a cryptographic key; and
a controller configured to operate the cryptography module to perform the one or more cryptographic operations on the user data, and further configured to, in response to receiving a key initialization request from the host device:
generate or retrieve a device key associated with the data storage device;
transmit the device key to the host device;
receive, from the host device, a host key associated with the host device; and
generate the cryptographic key by combining the host key and the device key.

2. The device of claim 1, wherein the host key comprises a host identifier uniquely identifying a hardware component of the host device.

3. The device of claim 2, wherein the host identifier is a serial number of a processing device of the host device.

4. The device of claim 1, wherein the device key is generated by applying a cryptographic function to a device unique identifier (DUID) of the data storage device.

5. The device of claim 1, wherein the controller is further configured to store the host key and the device key in a secure area of the non-volatile storage medium.

6. The device of claim 1, wherein the controller is further configured to generate the cryptographic key in response to a data access request from the device, wherein performing the data access request comprises performing at least one of the one or more cryptographic operations.

7. The device of claim 1, wherein the controller is further configured to generate the cryptographic key by: applying a cryptographic function to the host key to generate an output value; and concatenating the output value with the device key.

8. The device of claim 1, wherein the cryptographic key is a symmetric encryption key.

9. The device of claim 1, wherein the controller is further configured to perform a write operation, and wherein performing the write operation comprises:
receiving the user data as part of a write command issued to the data storage device by the host device;
generating encrypted user data by encrypting the user data with the cryptographic key or an associated key forming a key pair with the cryptographic key; and
storing the encrypted user data in the user accessible area of the non-volatile storage medium.

10. The device of claim 9, wherein the controller is further configured to perform a read operation, and wherein performing the read operation comprises:
receiving, as part of a read command issued to the data storage device by the host device: an address of the encrypted user data; and a candidate key;
validating the read command using the candidate key and the device key; and
in response to a positive validation: (i) retrieving the encrypted user data from the user accessible area of the non-volatile storage medium; (ii) generating the user data by decrypting the encrypted user data with the cryptographic key or the associated key; and (iii) transmitting the user data to the host device.

11. A method, executed by at least one processor of a data storage device, for generating a cryptographic key used by the data storage device to perform one or more cryptographic operations on user data, wherein the method comprises:
receiving a key initialization request from a host device configured to exchange data with the data storage device;
in response to receiving the key initialization request, generating a device key associated with the data storage device;
transmitting the device key to the host device;
receiving, from the host device, a host key associated with the host device; and
generating the cryptographic key by combining the host key and the device key.

12. The method of claim 11, wherein the host device is configured to:
receive the device key in response to transmitting the key initialization request to the data storage device;
store the device key in a secure area of a memory of the host device; and
transmit the host key to the data storage device in response to receiving the device key.

13. The method of claim 11, wherein the host key comprises a host identifier uniquely identifying one or more hardware components of the host device.

14. The method of claim 11, wherein generating the device key comprises applying a cryptographic function to a device unique identifier (DUID) of the data storage device.

15. The method of claim 11, further comprising storing the host key and the device key in a secure area of the non-volatile storage medium.

16. The method of claim 11, further comprising generating the cryptographic key in response to a data access request from the host device, wherein performing the data access request comprises performing at least one of the one or more cryptographic operations.

17. The method of claim 11, further comprising generating the cryptographic key by:
applying a cryptographic function to the host key to generate an output value; and
concatenating the output value with the device key.

18. The method of claim 11, further comprising performing a write operation, and wherein performing the write operation comprises:
receiving, by the at least one processor, a write command issued by the host device, wherein the write command comprises the user data;
generating, by the at least one processor, encrypted user data by encrypting the user data with the cryptographic key or an associated key forming a key pair with the cryptographic key; and
storing, by the at least one processor, the encrypted user data in a user accessible area of the non-volatile storage medium.

19. The method of claim 18, further comprising performing a read operation, and wherein performing the read operation comprises:
receiving, by the at least one processor, a read command issued by the host device, wherein the read command comprises: an address of the encrypted user data; and a candidate key;
validating, by the at least one processor, the read command using the candidate key and the device key; and
in response to a positive validation: (i) retrieving, by the at least one processor, the encrypted user data from the user accessible area of the non-volatile storage medium; (ii) generating, by the at least one processor, the user data by decrypting the encrypted user data with the cryptographic key or the associated key; and (iii) transmitting, by the at least one processor, the user data to the host device.

20. A data storage device comprising:
means for storing user data in a non-volatile storage medium of the data storage device;
means for transmitting data between a host device and the data storage device;
means for performing one or more cryptographic operations on the user data using a cryptographic key; and
means for generating the cryptographic key by:
receiving, from the host device, a host key associated with the host device;
obtaining a device key associated with the data storage device, wherein the device key is transmitted from the data storage device to the host device; and
combining the host key and the device key.
